(19) United States
(12) Patent Application Publication
(10) Pub. No.: US 2006/0103591 A1
(43) Pub. Date: May 18, 2006

(54) Information processing apparatus and method for providing observer with information

(75) Inventors: Kaname Tanimura, Shinjuku-ku (JP); Takashi Aso, Yokohama-shi (JP); Toshikazu Ohshima, Kawasaki-shi (JP)

Correspondence Address: Canon U.S.A. Inc.;Intellectual Property Division, 15975 Alton Parkway, Irvine, CA, 92618-3731, US

(73) Assignee: Canon Kabushiki Kaisha, Ohta-ku (JP)

(21) Appl. No.: 11/271,635

(22) Filed: Nov. 10, 2005

(30) Foreign Application Priority Data
Nov. 15, 2004 (JP) 2004-331104

(51) Int. Cl. G09G 5/00

(52) U.S. Cl. 345/8

(57) ABSTRACT

There is provided a technology for controlling information to be supplied to an observer depending on a state of an apparatus, namely, whether the observer is receiving information. A use state of a head-mounted display device, for example, the position and/or orientation of the head-mounted display device is detected to control the power supply of the head-mounted display device based on the detected use state.

### BACKGROUND OF THE INVENTION

1. Field of the Invention

The present invention relates to an information processing apparatus for providing an observer with information.

2. Description of the Related Art

Recent technology has enabled three-dimensional images to be reproduced in a virtual space or a composite real space (hereinafter, both spaces are referred to as the “virtual space”) by using a head-mounted display (hereinafter, abbreviated as the HMD) or a hand-held display (hereinafter, abbreviated as the HHD) including a liquid crystal monitor each on the left and the right (see, for example, Japanese Patent Laid-Open No. 11-088913 (corresponding to U.S. Pat. No. 6,522,312)).

By utilizing this technique, data of a prototype can be presented in the form of a finished product in the virtual space for the purposes of verifying the design and so on.

However, a typical HMD/HHD is constructed such that the liquid crystal displays are mounted in front of the eyes of the user, like standard glasses. For this reason, the user can see only the image displayed on the HMD/HHD. Furthermore, even if various graphical user interfaces (GUIs) are provided for display on the HMD/HHD, system operation by drawing upon such GUI information displayed in small size on the HMD/HHD is difficult due to insufficient resolution of the HMD/HHD. Therefore, the user with the HMD/HHD mounted has difficulty in performing various operations and feels irritated by low working speed.

When a typical virtual reality system for providing an observer with a virtual space is started up, the observer can experience the virtual space by observing images continuously displayed on the HMD/HHD.

However, even after the observer takes off the HMD/HHD, the HMD/HHD continues to display images thereon. This is wasteful because no one sees the images displayed on the HMD/HHD.

Some virtual reality systems provide not only images but also audio. These systems may also experience similar problems.

The above-described problems can be rephrased as wasting the power supply for driving the system that provides the observer with information. Therefore, the provision of information by the system needs to be controlled depending on whether the observer is receiving the information.

### SUMMARY OF THE INVENTION

In light of the above-described circumstances, the present invention provides technology for controlling power supply according to a state of the HMD.

The present invention also provides technology for controlling provision of information to an observer depending on whether that observer is receiving the information.

The present invention further provides technology for providing an observer with information appropriate for the observer.

According to one aspect of the present invention, an information processing apparatus includes a determination unit configured to determine a use state of a display device for displaying an image in front of an eye of an observer; and a control unit configured to control a power supply of the display device based on the use state of the display device determined by the determination unit.

According to another aspect of the present invention, an information processing apparatus includes a first supply unit configured to supply an image to a first display device for displaying the image in front of an eye of an observer; a second supply unit configured to supply an image to a second display device for displaying the image in a different format from the format of the first display device; a reception unit configured to receive at least one of position information and orientation information about the first display device; and a control unit configured to control a size of an image displayed on the second display device based on at least one of the position information and the orientation information received by the reception unit.

According to still another aspect of the present invention, an information processing apparatus includes a supply unit configured to supply an image to a display device for displaying the image in front of an eye of an observer; a detection unit configured to detect information about the observer; and a restriction unit configured to restrict the image supplied to the display device based on the information detected by the detection unit.

According to still another aspect of the present invention, an information processing method includes a determining step of determining a use state of a display device for displaying an image in front of an eye of an observer; and a controlling step of controlling a power supply of the display device based on the use state of the display device determined in the determining step.

According to still another aspect of the present invention, an information processing method includes a first supplying step of supplying an image to a first display device for displaying the image in front of an eye of an observer; a second supplying step of supplying an image to a second display device for displaying the image in a different format from the format of the first display device; a receiving step of receiving at least one of position information and orientation information about the first display device; and a controlling step of controlling a size of an image displayed on the second display device based on at least one of the position information and the orientation information received in the receiving step.

According to yet another aspect of the present invention, an information processing method includes a supplying step of supplying an image to a display device for displaying the image in front of an eye of an observer; a detecting step of detecting information about the observer; and a restricting step of restricting the image supplied to the display device based on the information detected in the detecting step.

Further features of the present invention will become apparent from the following description of exemplary embodiments (with reference to the attached drawings).

### BRIEF DESCRIPTION OF THE DRAWINGS

FIG. 1 is a block diagram depicting a functional structure of a system according to a first embodiment of the present invention.

FIG. 2 is a diagram depicting an observer having a head-mounted display device on the head, who is looking at a teapot, as a virtual object, placed on a table, as a real object.

FIG. 3 is a flowchart illustrating power control processing for a head-mounted display device according to <Check Process 1> carried out by a computer.

FIG. 4 is a flowchart illustrating power control processing for a head-mounted display device according to <Check Process 2> carried out by a computer.

FIG. 5 is a flowchart illustrating power control processing for a head-mounted display device according to <Check Process 3> carried out by a computer.

FIG. 6 is a block diagram depicting a functional structure of a second embodiment according to the present invention.

FIG. 7 is a flowchart illustrating power control processing for an audio input device carried out by a computer.

FIG. 8 is a diagram depicting a functional structure of a system according to a third embodiment of the present invention.

FIG. 9 is a diagram depicting an observer having a head-mounted display device on the head, who is looking at a teapot, as a virtual object, placed on a table, as a real object.

FIG. 10 is a flowchart for power control processing carried out by a computer for a liquid crystal display device and a head-mounted display device.

FIG. 11 is a diagram depicting different display sizes of a GUI on a liquid crystal display device.

FIG. 12 is a diagram depicting a functional structure of a system according to a fourth embodiment of the present invention.

FIG. 13 is a flowchart for the process of changing the size of a GUI displayed on a liquid crystal display device by a computer.

FIG. 14 is a block diagram depicting a functional structure of a fifth embodiment according to the present invention.

FIG. 15 is a flowchart for the process of controlling a command input from an input device, such as a keyboard and a mouse, carried out by a computer.

FIG. 16 is a block diagram depicting a basic structure of a system according to the first embodiment of the present invention.

FIG. 17 is a block diagram depicting a basic structure of a system according to the second embodiment of the present invention.

FIG. 18 is a block diagram depicting a basic structure of a system according to the third embodiment of the present invention.

### DESCRIPTION OF THE EMBODIMENTS

Exemplary embodiments of the present invention will now be described in detail with reference to the attached drawings.

### First Embodiment

In a system according to this embodiment, it is determined whether an observer expected to see a virtual space on an HMD/HHD (hereinafter, may also be referred to as the “display device”) is looking at the display screen of this display device. If it is determined that the observer is not looking at the display screen of the display device, the power supply of the display device is turned OFF because image display on the display device is wasteful. On the other hand, if it is determined that the observer is looking at the display screen of the display device, image display by the display device is determined as effective, and supply of power to the display device is continued. This system will be described below.

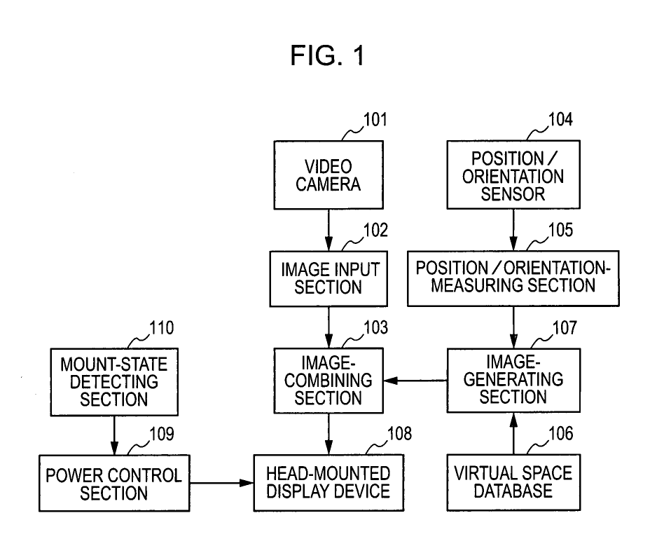

FIG. 1 is a block diagram depicting a functional structure of the system according to the first embodiment of the present invention.

A video camera 101 is mounted on a head-mounted display device (hereinafter, referred to as the HMD) 108 placed on the head of an observer to continuously acquire images of the real space as seen from the viewpoint according to the position/orientation of the observer. An image signal of each of the acquired frames is output from the video camera 101 to an image input section 102. Since the video camera 101 functions as a viewpoint of the observer, when the head-mounted display device 108 is mounted on the head of the observer, the video camera 101 should be positioned as close as possible to the viewpoint (eyes) of the observer.

The description below also applies when the user uses a hand-held display device (hereinafter, referred to as the HHD) instead of the head-mounted display device 108.

The image input section 102 sends an image signal output from the video camera 101 to an image-combining section 103 as digital image data.

A position/orientation sensor 104 is mounted on the head-mounted display device 108. It detects a change in a magnetic field generated by a transmitter (not shown) and outputs the detection result as a signal to a position/orientation-measuring section 105. The signal of the detection result indicates a change in the magnetic field detected according to a change in the position/orientation of the position/orientation sensor 104. Such a change is measured in a coordinate system having the position of the transmitter as the origin where three axes x, y, and z orthogonal to one another at the origin are assumed (hereinafter, this coordinate system is referred to as the sensor coordinate system).

Based on the signal of the detection result, the position/orientation-measuring section 105 obtains the position/orientation of the position/orientation sensor 104 in the sensor coordinate system. The data indicating the position/orientation of the position/orientation sensor 104 in the sensor coordinate system obtained by the position/orientation-measuring section 105 is sent to an image-generating section 107.

The image-generating section 107 adds a pre-measured “positional/orientational relationship between the position/orientation sensor 104 and the video camera 101” to the “position/orientation of the position/orientation sensor 104 in the sensor coordinate system” indicated by this data to obtain the “position/orientation of the video camera 101 in the sensor coordinate system.” It is assumed that the data indicating the pre-measured “positional/orientational relationship between the position/orientation sensor 104 and the video camera 101” is pre-stored in a virtual space database 106 to be described later.

Data associated with at least one virtual object constituting the virtual space is registered in the virtual space database 106. Data associated with a virtual object refers to data required to draw video images of the virtual object, such as vertex data and normal data of each polygon, texture data and initial-position data of the virtual object, and so on if the virtual object is constructed in polygons. As described above, the virtual space database 106 further stores data indicating the pre-measured “positional/orientational relationship between the position/orientation sensor 104 and the video camera 101”.

The image-generating section 107 arranges virtual objects in the virtual space by using data associated with the virtual objects stored in the virtual space database 106, generates a video image of the virtual space seen from the viewpoint (the video camera 101) at the position/orientation obtained by the position/orientation-measuring section 105, and sends data of the generated image to the image-combining section 103.

The image-combining section 103 superimposes the image of the virtual space received from the image-generating section 107 upon the image of the real space received from the image input section 102 and outputs the resultant image to the HMD 108. As is known, the HMD 108 is provided with a display section. This display section is provided on the HMD 108 so as to position itself in front of the eyes of the observer when the observer puts the HMD 108 on his or her head. Images based on image signals sent from the image-combining section 103 are displayed on the display section. Therefore, an image generated by the image-combining section 103 (i.e., an image of the virtual space superimposed upon the image of the real space) is presented in front of the eyes of the observer.

A mount-state detecting section 110 determines whether the observer is looking at the image displayed on the HMD 108.

A power control section 109 controls ON/OFF of the power supply of the HMD 108 based on a determination result by the mount-state detecting section 110. More specifically, if the power control section 109 receives from the mount-state detecting section 110 notification indicating that “the observer is looking at the image displayed on the HMD 108,” the power control section 109 turns ON (or keeps ON) the power supply of the HMD 108. On the other hand, if the power control section 109 receives from the mount-state detecting section 110 notification indicating that “the observer is not looking at the image displayed on the HMD 108,” the power control section 109 carries out the process of turning OFF the power supply of the HMD 108.

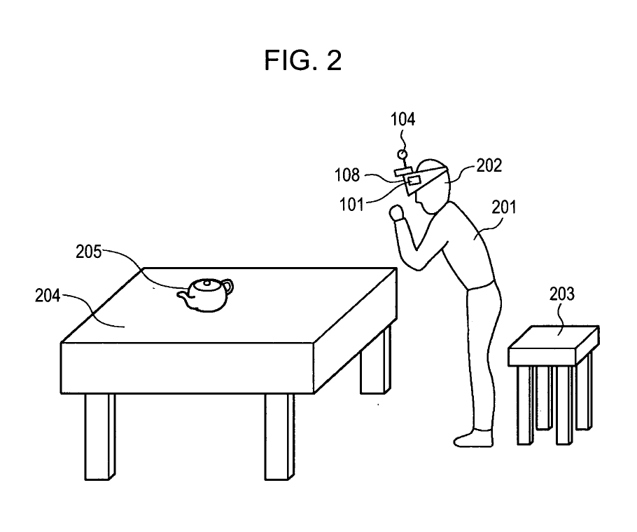

FIG. 2 is a diagram depicting an observer 201 having the HMD 108 on a head 202, who is looking at a teapot 205, as a virtual object, placed on a table 204, as a real object.

As shown in FIG. 2, the HMD 108 is provided with the position/orientation sensor 104 and the video camera 101. Therefore, the video camera 101 captures an image of the real space as seen from the position thereof, which changes according to the position/orientation of the head 202 of the observer 201. Furthermore, the position/orientation of the position/orientation sensor 104 also changes as the position/orientation of the head 202 of the observer 201 changes. This change in the position/orientation sensor 104 is measured.

When the observer 201 removes the HMD 108 from the head 202, he or she places the HMD 108 on a mounting stand 203. For system operation, the HMD 108 is first placed on the mounting stand 203.

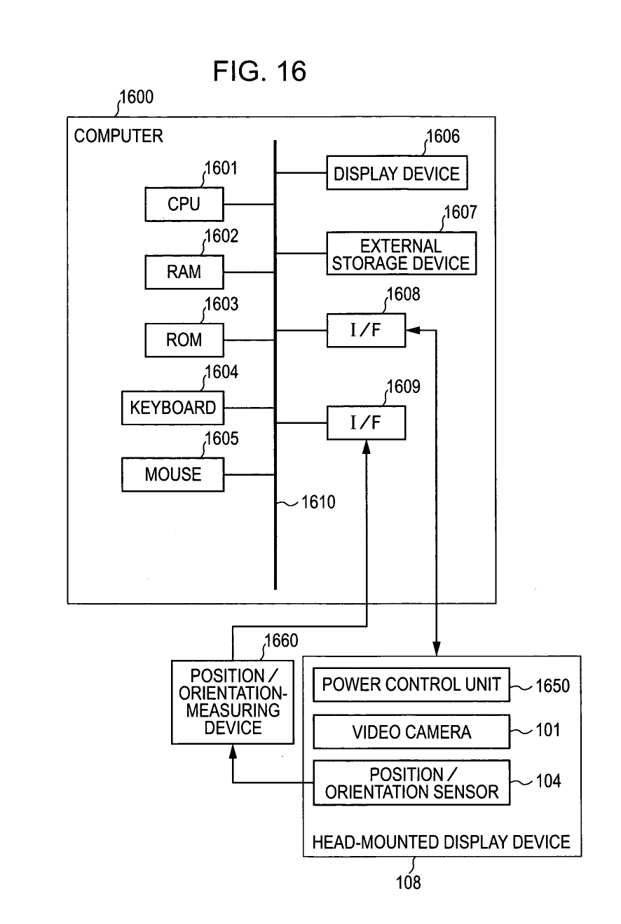

FIG. 16 is a block diagram depicting the basic structure of the system according to this embodiment of the present invention. As shown in FIG. 16, the system includes a computer 1600, the HMD 108, and a position/orientation-measuring device 1660.

The computer 1600 will first be described. Central processing unit (CPU) 1601 controls the computer 1600 using programs and data stored in a random access memory (RAM) 1602 and a read-only memory (ROM) 1603. The CPU 1601 also carries out the processing to be described later by the computer 1600. The image-generating section 107, the image-combining section 103, and the mount-state detecting section 110 shown in FIG. 1 operate as part of the function of the CPU 1601.

The RAM 1602 includes an area for temporarily storing programs and data loaded from an external storage device 1607, an area for temporarily storing data received via each of downstream interfaces (I/Fs) 1608 and 1609, and a work area used by the CPU 1601 to carry out various types of processing.

The ROM 1603 stores setting data, a boot program, and so on for the computer 1600.

With input devices including a keyboard 1604 and a mouse 1605, various types of commands can be input to the CPU 1601.

A display device 1606 includes, for example, a cathode ray tube (CRT) and a liquid crystal screen. It can display a result of processing by the CPU 1601 in the form of images and characters.

The external storage device 1607 includes a large-capacity information storage device such as a hard disk drive device. It stores an operating system (OS) and programs and data used by the CPU 1601 to cause the computer 1600 to carry out the processing to be described later. More specifically, part or all of these programs and data is loaded from the external storage device 1607 to the RAM 1602 under the control of the CPU 1601, which then uses the loaded programs and data to cause the computer 1600 to carry out the processing described later. The virtual space database 106 shown in FIG. 1 operates as part of the function of this external storage device 1607.

The HMD 108 is connected to the computer 1600 via the I/F 1608. The computer 1600 sends and receives data to and from the HMD 108 via the I/F 1608. The image input section 102 shown in FIG. 1 operates as part of the function of the I/F 1608.

The position/orientation-measuring device 1660 is connected to the computer 1600 via the I/F 1609. The computer 1600 receives data from the position/orientation-measuring device 1660 via the I/F 1609.

A bus 1610 interconnects the above-described components.

Instead of the computer 1600, hardware dedicated to the same processing or a workstation may be used.

The HMD 108 will now be described. As described above, the HMD 108 includes the video camera 101, the position/orientation sensor 104, and a power control unit 1650. The power control unit 1650 turns ON/OFF the power supply of the HMD 108 according to a command from the computer 1600. The power control section 109 shown in FIG. 1 corresponds to the power control unit 1650.

The position/orientation-measuring device 1660 will now be described. The position/orientation-measuring device 1660 corresponds to the above-described position/orientation-measuring section 105. It sends a signal received from the position/orientation sensor 104 to the I/F 1609 as digital data.

Various types of processing for checking whether the observer is looking at images displayed on the HMD 108 will be described below.

<Check Process 1>

While not in use, the HMD 108 is placed on the mounting stand 203. Hereinafter, the position of the HMD 108 placed on the mounting stand 203 may be referred to as the initial position. When the observer is looking at the image displayed on the HMD 108, it is needless to say that the HMD 108 is not placed on the mounting stand 203 but mounted on the head of the observer.

More specifically, checking as to whether the observer is looking at the image displayed on the HMD 108 can be accomplished by checking whether the HMD 108 is on the mounting stand 203.

In order to check whether the HMD 108 is placed on the mounting stand 203, the position of the video camera 101 is utilized. First, the HMD 108 is placed on the mounting stand 203, the position in the sensor coordinate system at that time (predetermined position on the mounting stand 203) is measured as the initial position, and this measurement is registered in the virtual space database 106 as data.

Therefore, if the observer 201 does nothing, the position of the video camera 101 is close to this initial position. More specifically, the distance between the video camera 101 and the initial position is substantially 0. However, when the observer 201 attempts to put the HMD 108 on his or her head 202, this distance will not be 0. The mount-state detecting section 110 continuously measures this distance to determine that the observer 201 is attempting to take the HMD 108 placed on the mounting stand 203 and put it on his or her head 202 and informs the power control section 109 of this fact if this distance is equal to or larger than a predetermined distance. In response, the power control section 109 turns ON the power supply of the HMD 108. On the other hand, if this distance is smaller than the predetermined distance, the mount-state detecting section 110 determines that the observer 201 is not attempting to put the HMD 108 on his or her head 202, and informs the power control section 109 of this fact. In response, the power control section 109 turns OFF (or keeps OFF) the power supply of the HMD 108.

As described above, the process of controlling power ON/OFF of the HMD 108 is carried out based on the distance between the video camera 101 and the initial position. Here, this “predetermined distance” may be determined appropriately according to the system configuration. In addition to the above-described processing, power ON/OFF control may be realized by, for example, checking whether the orientation of the video camera 101 obtained by the position/orientation-measuring section 105 indicates substantially 90 degrees (vertically upward) to determine that the observer 201 is attempting to take the HMD 108 placed on the mounting stand 203 to put it on his or her head 202 and turn ON the power supply of the HMD 108.

Furthermore, the initial position/orientation of the HMD 108 on the mounting stand 203 may be pre-acquired and it may be checked whether the current position/orientation of the video camera 101 differs from this initial position/orientation by at least a predetermined amount to determine that the observer 201 is attempting to take the HMD 108 placed on the mounting stand 203 to put it on his or her head 202 and turn ON the power supply of the HMD 108.

As described above, there are no restrictions upon how to utilize the position component and the orientation component of the video camera 101 to determine whether or not the observer 201 is attempting to take the HMD 108 placed on the mounting stand 203 to put it on his or her head 202.

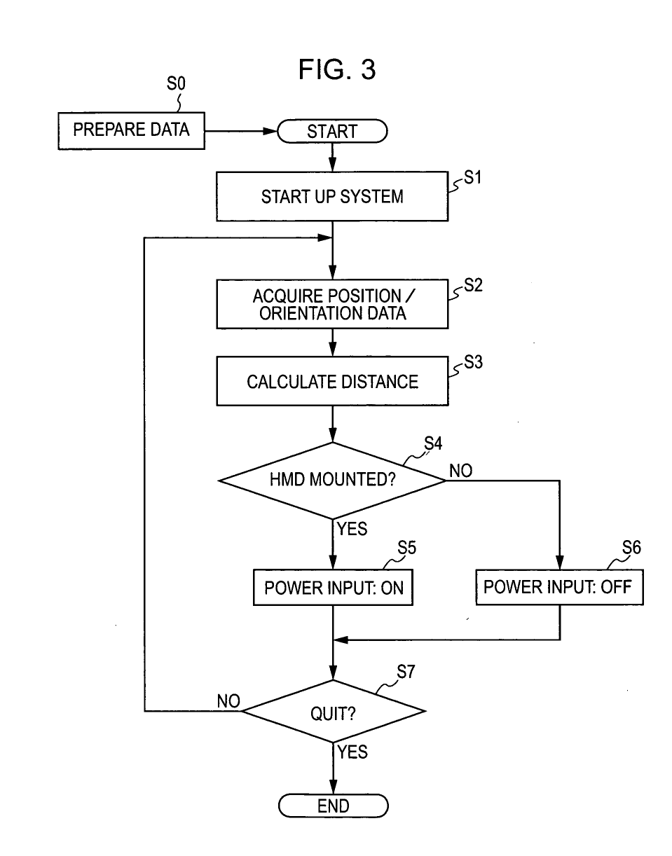

FIG. 3 is a flowchart illustrating power control processing for the HMD 108 according to <Check Process 1> carried out by the computer 1600. Programs and data used by the CPU 1601 to carry out the processing in accordance with the flowchart shown in FIG. 3 are saved in the external storage device 1607. These programs and data are loaded in the RAM 1602 under the control of the CPU 1601, which then uses the loaded programs and data to enable the computer 1600 to carry out the processing to be described later.

The processing in accordance with the flowchart shown in FIG. 3 can be called as a subroutine, for example, while this system is presenting the observer with information (the image of the virtual space superimposed upon the image of the real space in this embodiment). For example, the processing in accordance with the flowchart shown in FIG. 3 can be performed at predetermined intervals of time.

First, in a preliminary step for the following processing, the initial position (position in the sensor coordinate system) of the HMD 108 on the mounting stand 203 is measured and that measurement is registered in the external storage device 1607 as data (step S0).

This system is then started up (step S1). A signal indicating the “position/orientation of the position/orientation sensor 104 in the sensor coordinate system” is input from the position/orientation sensor 104 provided in the HMD 108 to the position/orientation-measuring device 1660. The position/orientation-measuring device 1660 sends this signal as data to the RAM 1602 via the I/F 1609. The CPU 1601 adds the pre-measured “positional/orientational relationship between the position/orientation sensor 104 and the video camera 101” to the “position/orientation of the position/orientation sensor 104 in the sensor coordinate system” indicated by this data to obtain the “position/orientation of the video camera 101 in the sensor coordinate system” (step S2).

Then, the distance between the initial position pre-registered in the external storage device 1607 in step S0 and the position obtained in step S2 is calculated (step S3). Then, it is determined whether this distance is equal to or larger than the predetermined distance (step S4). In other words, the processing in step S4 is carried out to determine whether the observer is attempting to put the HMD 108 on his or her head.

If the distance obtained in step S3 is equal to or larger than the predetermined distance (if the observer is attempting to put the HMD 108 on his or her head), the flow proceeds to step S5, where the CPU 1601 sends a command for turning ON the power supply to the power control unit 1650 provided in the HMD 108 (step S5). In response, the power control unit 1650 turns ON the power supply of the HMD 108.

On the other hand, if the distance obtained in step S3 is smaller than the predetermined distance (if the observer is not attempting to put the HMD 108 on his or her head), the flow is advanced to step S6, where the CPU 1601 sends a command for turning OFF the power supply to the power control unit 1650 provided in the HMD 108 (step S6). In response, the power control unit 1650 turns OFF the power supply of the HMD 108.

If a command for quitting the above-described processing is input on, for example, the keyboard 1604 or the mouse 1605 provided in the computer 1600 and the CPU 1601 detects this input, then this processing is ended. If the CPU 1601 does not detect such an input, the flow returns to step S2 to repeat the processing in step S2 and the subsequent processing.

<Check Process 2>

In Check Process 2, a line-of-sight detecting device is used as the power control unit 1650. More specifically, in order to carry out Check Process 2, the line-of-sight detecting device is mounted at a position satisfying the following two conditions: the position is close to the display section of the HMD 108 and the position allows the line of sight to be detected when the observer having the HMD 108 on his or her head sees the display section. Then, if such a line of sight is detected by the line-of-sight detecting device, the computer 1600 is informed of this fact. When the CPU 1601 receives this notification, it determines that the observer is looking at the image displayed on the HMD 108 and therefore instructs the power control unit 1650 to turn ON the power supply of the HMD 108. In response, the power control unit 1650 turns ON (or keeps ON) the power supply of the HMD 108.

On the other hand, if the line-of-sight detecting device does not detect the above-described line of sight, the computer 1600 is informed of this fact. When the CPU 1601 receives this notification, it determines that the observer is not looking at the image displayed on the HMD 108 and therefore instructs the power control unit 1650 to turn OFF the power supply of the HMD 108. In response, the power control unit 1650 turns OFF the power supply of the HMD 108.

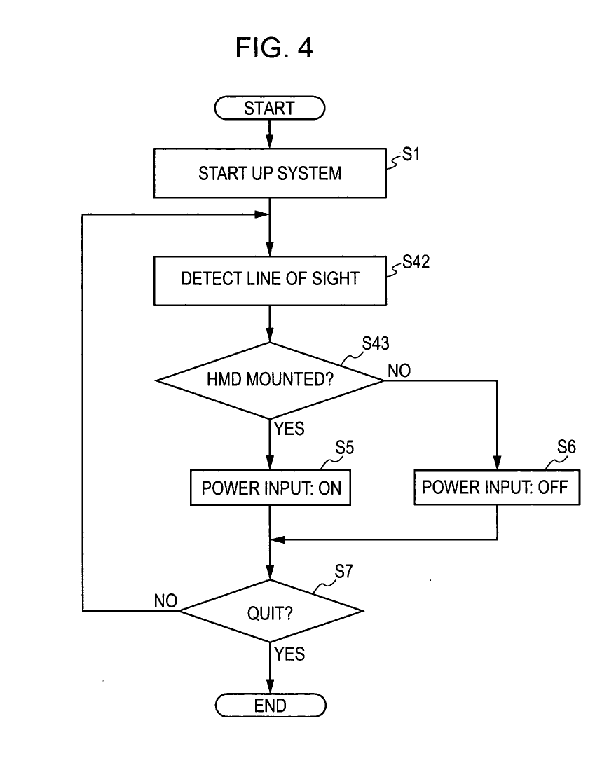

FIG. 4 is a flowchart illustrating power control processing for the HMD 108 according to <Check Process 2> carried out by the computer 1600. Programs and data used by the CPU 1601 to carry out the processing in accordance with the flowchart shown in FIG. 4 are saved in the external storage device 1607. These programs and data are loaded in the RAM 1602 under the control of the CPU 1601, which then uses the loaded programs and data to enable the computer 1600 to carry out the processing to be described later. The processing in accordance with the flowchart shown in FIG. 4 can be called as a subroutine, for example, while this system is presenting the observer with information (the image of the virtual space superimposed upon the image of the real space in this embodiment). For example, the processing in accordance with the flowchart shown in FIG. 4 can be performed at predetermined intervals of time. The same process steps in FIG. 4 as those shown in FIG. 3 are denoted with the same step numbers, and thus will not be described again here.

In step S42, the process of detecting a line of sight of the observer is carried out with the line-of-sight detecting device, and a detection result of this process is received. The process of detecting a line of sight is known to persons of ordinary skill in the art, and will not be described herein.

The CPU 1601 then refers to this detection result, and in step S43 determines whether the HMD is on the observer's head. If a line of sight is detected in step S42, then it is determined that the HMD is mounted on the observer's head and the CPU 1601 advances the flow from step S43 to step S5. The processing in step S5 has been described above. On the other hand, no line of sight is detected in step S42, then it is determined in step S43 that the HMD is not mounted on the observer's head and the flow is advanced from step S43 to step S6. The processing in step S6 has been described above.

<Check Process 3>

In Check Process 3, the HMD 108 is provided with a switch so that the observer can depress this switch to see the image on the HMD 108. When the switch is depressed, the power control unit 1650 informs the computer 1600 that the switch is depressed. When the computer 1600 receives this notification, it interprets that the “HMD 108 is in use” and sends to the power control unit 1650 notification demanding that the power supply of the HMD 108 be turned ON. In response, the power control unit 1650 turns ON the power supply of the HMD 108.

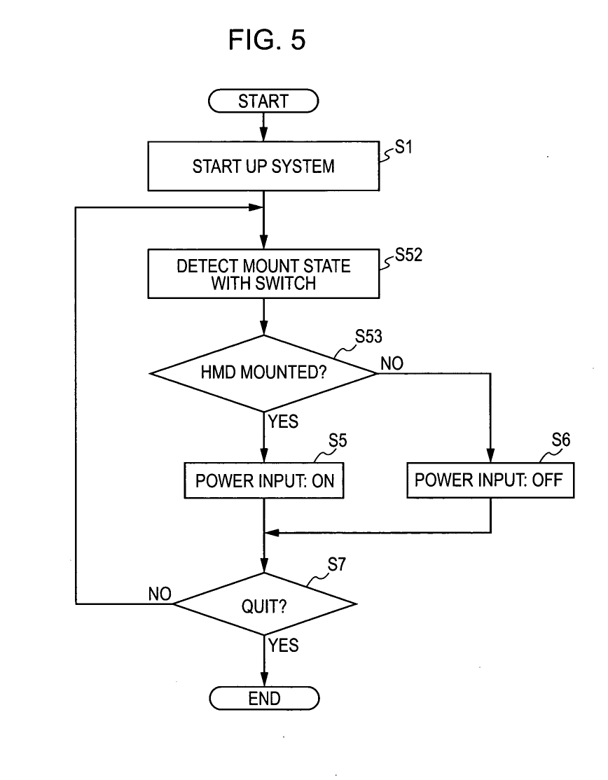

FIG. 5 is a flowchart illustrating power control processing for the head-mounted display device 108 according to <Check Process 3> carried out by the computer 1600. Programs and data used by the CPU 1601 to carry out the processing in accordance with the flowchart shown in FIG. 5 are saved in the external storage device 1607. These programs and data are loaded in the RAM 1602 under the control of the CPU 1601, which then uses the loaded programs and data to enable the computer 1600 to carry out the processing to be described later. The processing in accordance with the flowchart shown in FIG. 5 can be called as a subroutine, for example, while this system is presenting the observer with information (the image of the virtual space superimposed upon the image of the real space in this embodiment). For example, the processing in accordance with the flowchart shown in FIG. 5 can be performed at predetermined intervals of time. The same process steps in FIG. 5 as those shown in FIG. 3 are denoted with the same step numbers, and thus will not be described again here.

In step S52, the depression state of the switch provided in the power control unit 1650 is detected by the power control unit 1650, and this detection result is received. In step S53, the CPU 1601 refers to this detection result, and advances the flow to step S5 if the switch is depressed. The processing in step S5 has been described above.

On the other hand, if it is determined that the switch has not been depressed, the flow is advanced from step S53 to step S6. In this exemplary embodiment, the switch stays depressed until the HMD is removed from the observer's head and when the HMD is removed, the switch returns to its not depressed state. The processing in step S6 has been described above.

In exemplary embodiments, a power off switch may be included in addition to or instead of the power on switch. In such cases, if the power off switch is detected, it is determined that the HMD is not mounted, and the CPU 1601 sends a command for turning OFF the power supply to the power control unit 1650 provided in the HMD 108. In response, the power control unit 1650 turns OFF the power supply of the HMD 108.

As described above, according to this embodiment, power ON/OFF control of the HMD 108 can be carried out depending on whether the observer is looking at the image supplied to the observer. This is advantageous in system power saving.

Although this embodiment uses a magnetic sensor, the sensor is not limited to a magnetic sensor. Alternatively, an optical sensor, an ultrasound sensor, a mechanical sensor, or the like may be used depending on the application.

In this embodiment, ON/OFF control of the power supply of the HMD 108 in the system for providing the observer with combined images of the real space and the virtual space has been described. However, the above-described power ON/OFF control processing is not limited for such a system. The above-described “ON/OFF control of the power supply of the HMD 108” can also be applied, for example, to a system for providing the observer with only the virtual space (images composed of only the virtual space are displayed on the HMD 108).

It will be appreciated that the above-described check processes can be performed in any combination. For example, an embodiment may include any one of the check processes, any combination of two of the check processes or all of the check processes.

Furthermore, it will be appreciated that the determination of whether the HMD is mounted on the observer's head can be done by using other methods. For example, if detection of movement of the HMD has occurred within less than a predetermined amount of time, it can be determined that the HMD is mounted, and if detection of movement of the HMD has not occurred for at least the predetermined amount of time, it may be determined that the HMD is not mounted.

### Second Embodiment

A system according to this embodiment not only outputs combined image of the virtual space and the real space to the HMD 108, but also enables audio input. Audio input is carried out by verbally inputting a desired command. Audio input can be carried out only when the observer is looking at the image displayed on the HMD 108. In other words, audio input is disabled if the observer is not looking at the image displayed on the HMD 108. This system will be described below.

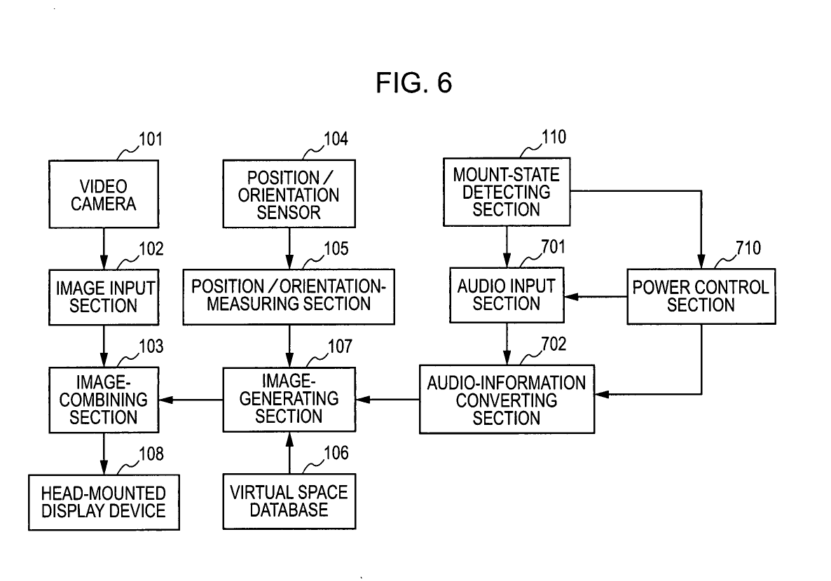

FIG. 6 is a block diagram depicting a functional structure of this embodiment according to the present invention. The same components in FIG. 6 as those shown in FIG. 1 are denoted with the same reference numerals, and thus will not be described again here.

An audio input section 701 inputs audio issued from the observer. An audio-information converting section 702 carries put the process of converting audio input from the audio input section 701 into a command interpretable to this system. The converted command is sent to the image generating section 107, where an image according to the command is generated.

A power control section 710 carries out power ON/OFF control processing according to notification from the mount-state detecting section 110 as in the first embodiment. Unlike in the first embodiment, however, power ON/OFF control processing is carried out for the audio input section 701 and the audio-information converting section 702 rather than for the HMD 108.

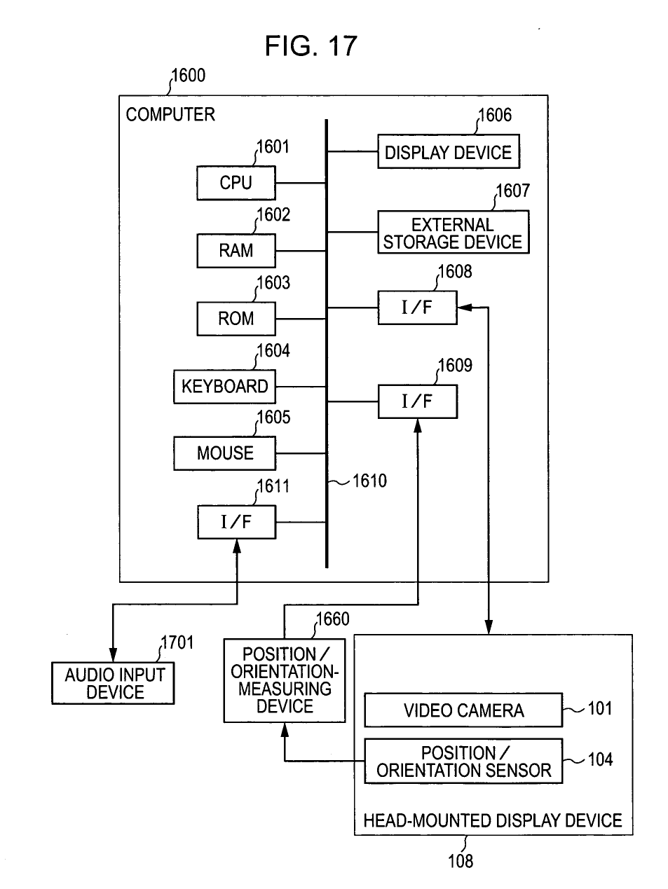

FIG. 17 is a block diagram depicting the basic structure of the system according to this embodiment of the present invention. The system according to this embodiment differs from the system according to the first embodiment in that the system according to this embodiment is additionally provided with an audio input device 1701 and that the HMD 108 is not provided with the power control unit. The audio input device 1701 includes the audio input section 701 and the power control section 710 shown in FIG. 6.

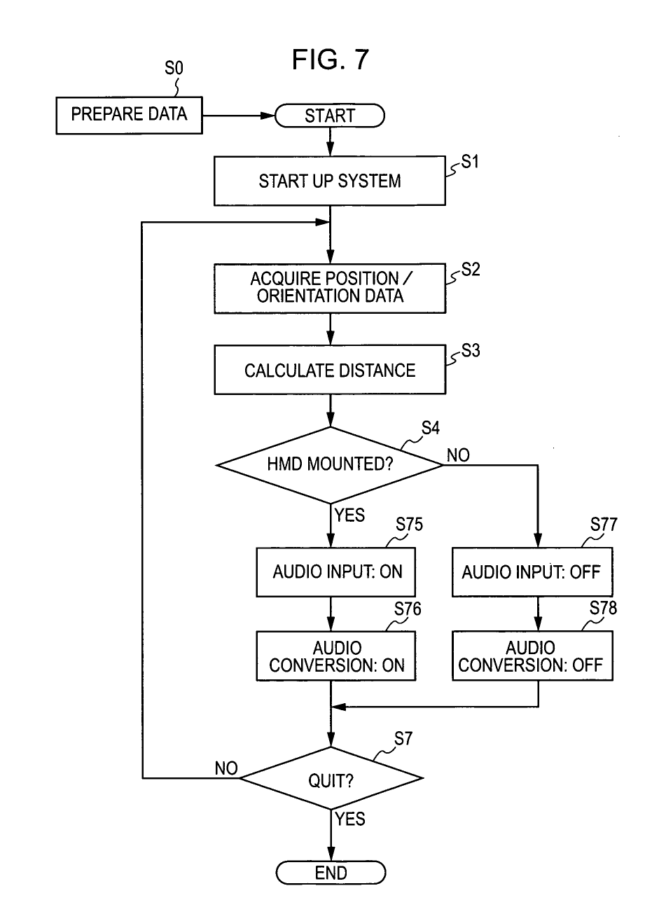

FIG. 7 is a flowchart illustrating power control processing for the audio input device 1701 carried out by the computer 1600. Programs and data used by the CPU 1601 to carry out the processing in accordance with the flowchart shown in FIG. 7 are saved in the external storage device 1607. These programs and data are loaded in the RAM 1602 under the control of the CPU 1601, which then uses the loaded programs and data to enable the computer 1600 to carry out the processing to be described later. The processing in accordance with the flowchart shown in FIG. 7 can be called as a subroutine, for example, while this system is presenting the observer with information (the image of the virtual space superimposed upon the image of the real space in this embodiment). For example, the processing in accordance with the flowchart shown in FIG. 7 can be performed at predetermined intervals of time. The same process steps in FIG. 7 as those shown in FIG. 3 are denoted with the same step numbers, and thus will not be described again here.

In step S4, if it is determined that the distance between the initial position pre-registered in the external storage device 1607 in step S0 and the position obtained in step S2 is at least a predetermined distance, the flow is advanced to step S75. The CPU 1601 sends to the audio input device 1701 a command for turning ON the audio input section 701 provided in the audio input device 1701 (step S75).

In addition, the CPU 1601 sends to the audio input device 1701 a command for turning ON the audio-information converting section 702 provided in the audio input device 1701 (step S76). Based on this processing, the audio input device 1701 turns ON the power supply of the audio input section 701 and the audio-information converting section 702.

As a result, not only can audio be input to the audio input device 1701, but also the input audio can be converted into a command interpretable to the system.

On the other hand, if the distance obtained in step S3 is smaller than the predetermined distance, the flow is advanced to step S77. The CPU 1601 sends to the audio input device 1701 a command for turning OFF the audio input section 701 provided in the audio input device 1701 (step S77). In addition, the CPU 1601 sends to the audio input device 1701 a command for turning OFF the audio-information converting section 702 provided in the audio input device 1701 (step S78). Based on this processing, the audio input device 1701 turns OFF the power supply of the audio input section 701 and the audio-information converting section 702.

With the above-described processing, power ON/OFF control processing of the audio input device 1701 can be carried out depending on whether the observer is looking at the image displayed on the HMD 108.

As described in the first embodiment, other types of processing are also conceivable to determine whether the observer is looking at the image displayed on the HMD 108. For example, such a determination may be made by detecting a line of sight by the use of the above-described line-of-sight detecting device. In this case, if a line of sight is detected, the power supply of the audio input device 1701 is turned ON. If no line of sight is detected, the power supply of the audio input device 1701 is turned OFF.

In addition, such a determination may be made depending on whether the above-described switch provided in the HMD 108 is depressed. In this case, if the switch is depressed, the power supply of the audio input device 1701 is turned ON. If the switch is not depressed, the power supply of the audio input device 1701 is turned OFF.

As described above, various types of processing for determining whether or not the observer is looking at the image displayed on the HMD 108 are conceivable.

The process shown in FIG. 7 can be performed alone or in combination with other processes, such as those described above with reference to the first embodiment.

### Third Embodiment

A system according to this embodiment includes the HMD 108 and a liquid crystal display device, and turns ON the power supply of the HMD 108 and turns OFF the power supply of the liquid crystal display device if the observer is looking at the image displayed on the HMD 108. On the other hand, if the observer is not looking at the image displayed on the HMD 108, the power supply of HMD 108 is turned OFF and the power supply of the liquid crystal display device is turned ON. This system will be described below.

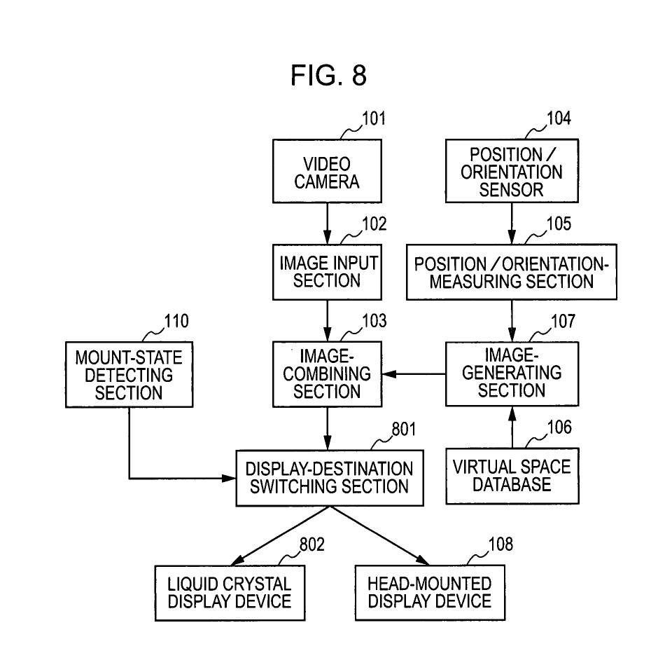

FIG. 8 is a diagram depicting a functional structure of the system according to this embodiment of the present invention. The same components in FIG. 8 as those shown in FIG. 1 are denoted with the same reference numerals, and thus will not be described again here.

A display-destination switching section 801 carries out the process of turning ON/OFF the power supply of a liquid crystal display device 802 and the HMD 108 based on a determination result by the mount-state detecting section 110. In addition to the processing described in the first embodiment, in this embodiment, the mount-state detecting section 110 also determines whether the observer is looking at the image displayed on the HMD 108, and according to this determination processing result, the display-destination switching section 801 turns ON one of the liquid crystal display device 802 and the HMD 108 and turns OFF the other.

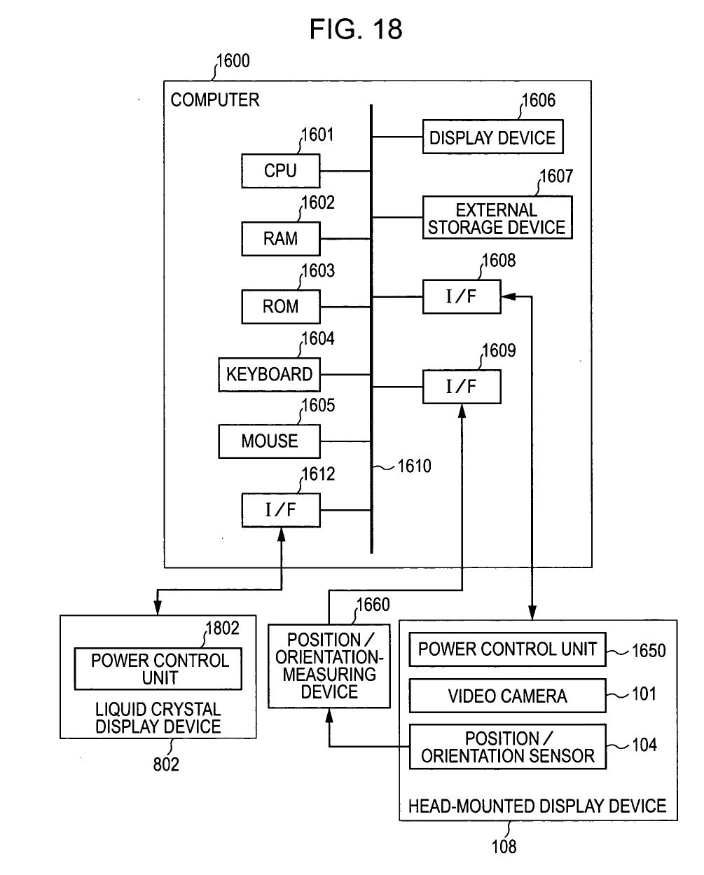

FIG. 18 is a block diagram depicting the basic structure of the system according to this embodiment of the present invention. The system according to this embodiment is provided with the liquid crystal display device 802 in addition to the system according to the first embodiment. The liquid crystal display device 802 is provided with a power control unit 1802 similar to the power control unit 1650 provided in the HMD 108. The power control unit 1802 carries out power ON/OFF control processing of the liquid crystal display device 802 according to a command from the computer 1600.

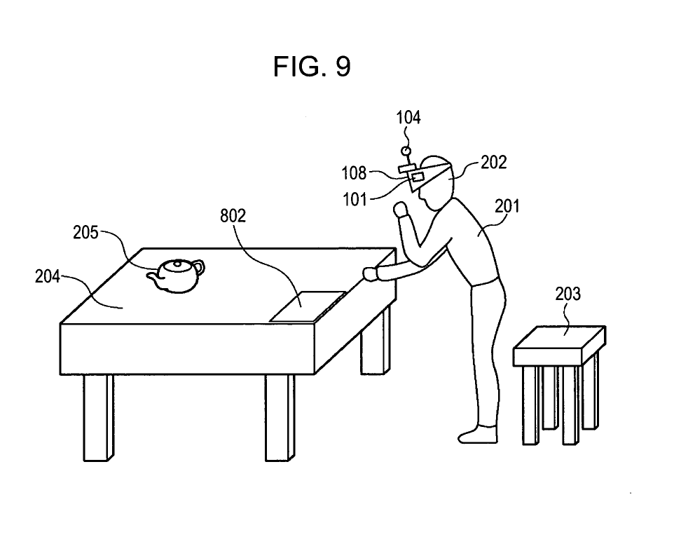

FIG. 9 is a diagram depicting an observer 201 having an HMD 108 on a head 202, who is looking at a teapot 205, as a virtual object, placed on a table 204, as a real object. The same components in FIG. 9 as those shown in FIG. 2 are denoted with the same reference numerals, and thus will not be described again here. As shown in FIG. 9, the liquid crystal display device 802 is disposed on the table 204, so that the observer 201 can see both the image displayed on the HMD 108 and the image displayed on the liquid crystal display device 802. As described above, an image is displayed on one of the display devices 108 and 802 depending on whether the observer is looking at the image displayed on the HMD 108. Thus, the observer 201 can see the image displayed on either of the two display devices 108 and 802.

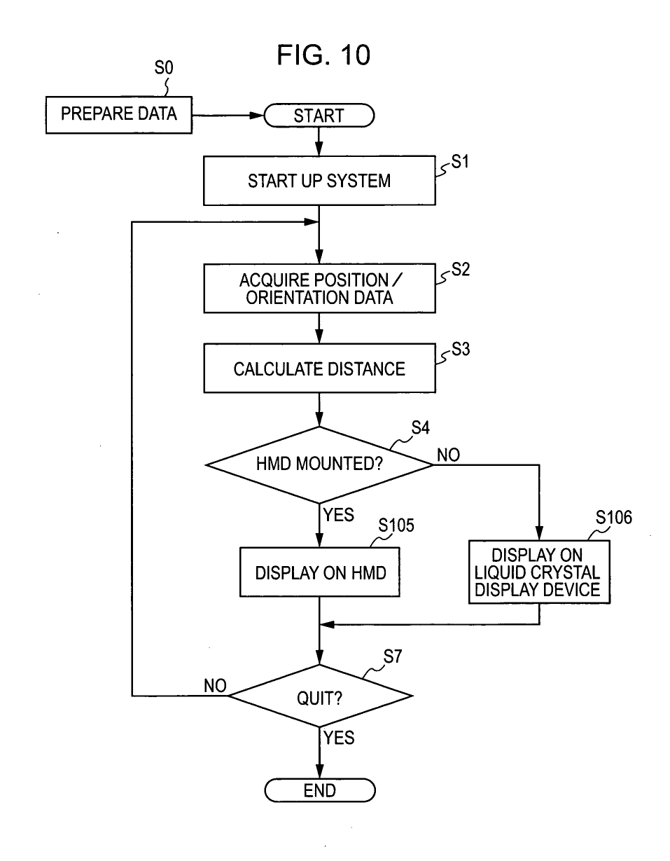

FIG. 10 is a flowchart for power control processing carried out by the computer 1600 for the liquid crystal display device 802 and the HMD 108. Programs and data used by the CPU 1601 to carry out the processing in accordance with the flowchart shown in FIG. 10 are saved in the external storage device 1607. These programs and data are loaded in the RAM 1602 under the control of the CPU 1601, which then uses the loaded programs and data to enable the computer 1600 to carry out the processing to be described later. The processing in accordance with the flowchart shown in FIG. 10 can be called as a subroutine, for example, while this system is presenting the observer with information (the image of the virtual space superimposed upon the image of the real space in this embodiment). For example, the processing in accordance with the flowchart shown in FIG. 10 can be performed at predetermined intervals of time. The same process steps in FIG. 10 as those shown in FIG. 3 are denoted with the same step numbers, and thus will not be described again here.

In step S4, if it is determined that the distance between the initial position pre-registered in the external storage device 1607 in step S0 and the position obtained in step S2 is at least a predetermined distance, the flow is advanced to step S105. First, the CPU 1601 sends a command for turning ON the power supply to the power control unit 1650, and then outputs a combined image of the real space and the virtual space to the HMD 108 (step S105). At this time, a command for turning OFF the power supply is sent to the power control unit 1802 of the liquid crystal display device 802, and therefore the power supply of the liquid crystal display device 802 is turned OFF. On the other hand, if the distance obtained in step S3 is smaller than the predetermined distance, the flow is advanced to step S106, where the CPU 1601 first sends a command for turning OFF the power supply to the power control unit 1650, sends a command for turning ON the power supply to the power control unit 1802 of the liquid crystal display device 802, and outputs a combined image of the real space and the virtual space to the liquid crystal display device 802 (step S106). By doing this, an image can be displayed on the display device that is likely to be observed by the observer. As described in the first embodiment, other types of processing are also conceivable to determine whether the observer is looking at the image displayed on the HMD 108. For example, such a determination may be made by detecting a line of sight by the use of the above-described line-of-sight detecting device. In this case, if a line of sight is detected, the power supply of the HMD 108 is turned ON. If no line of sight is detected, the power supply of the HMD 108 is turned OFF.

In addition, such a determination may be made depending on whether the above-described switch provided in the HMD 108 is depressed. In this case, if the switch is depressed, the power supply of the head-mounted display device 108 is turned ON. If the switch is not depressed, the power supply of the ahead-mounted display device 108 is turned OFF.

As described above, various types of processing for determining whether or not the observer is looking at the image displayed on the HMD 108 are conceivable.

Furthermore, although in the above-described processing the power supply of the display device that is not likely to be observed by the observer is turned OFF, this display device may be left ON.

In this embodiment, the power supplies of the liquid crystal display device 802 and the HMD 108 are controlled ON/OFF. Alternatively, the power supplies of the liquid crystal display device 802 and the HMD 108 may be left ON so that the output destination of an image to be displayed is switched to one of the liquid crystal display device 802 and the HMD 108. For this purpose, it is sufficient to replace the phrase “turn ON the power supply” with “set as an image output destination” and the phrase “turn OFF the power supply” with “not set as an image output destination” in the above description.

### Fourth Embodiment

In this embodiment, the display size of a graphical user interface (GUI) displayed on the liquid crystal display device 802 is changed according to whether the user is looking at the image on the HMD 108. In this embodiment, images are output to both the HMD 108 and the liquid crystal display device 802. However, because the observer sees information on the display screen of the liquid crystal display device 802 through the display section of the HMD 108, low resolution of the display section of the HMD 108 causes the observer to have difficulty in recognizing small characters on the liquid crystal display device 802 even though the liquid crystal display device 802 itself has high resolution.

In light of this point, display of a GUI on the liquid crystal display device 802 is controlled such that if the observer is not looking at the image displayed on the HMD 108, the GUI is displayed in normal size on the liquid crystal display device 802, whereas if the observer is looking at the image displayed on the HMD 108, the GUI is displayed in large size on the liquid crystal display device 802. As a result, characters on the GUI can be recognized despite low display resolution of the display section of the HMD 108.

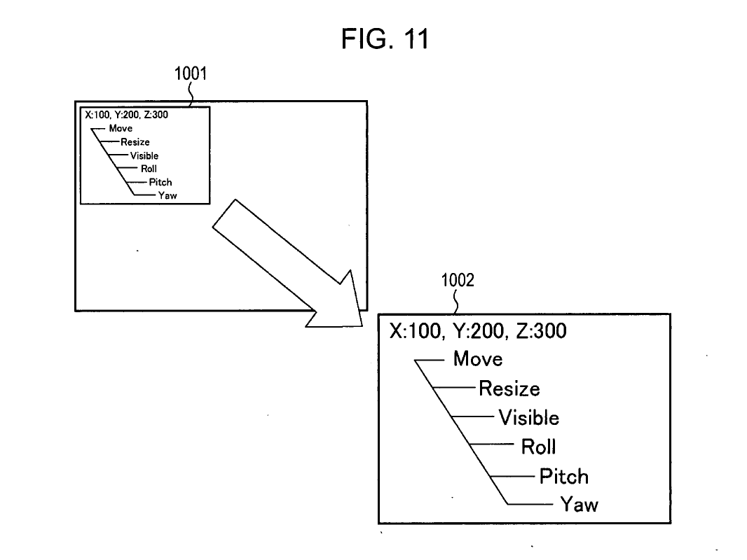

FIG. 11 is a diagram depicting different display sizes of the GUI on the liquid crystal display device 802. If the observer is not looking at the image displayed on the HMD 108, the GUI is displayed in normal size as shown by the normal sized GUI 1001 in FIG. 11. On the other hand, if the observer is looking at the image displayed on the HMD 108, the GUI is displayed in a size larger than the normal size, as shown by the large sized GUI 1002 in FIG. 11.

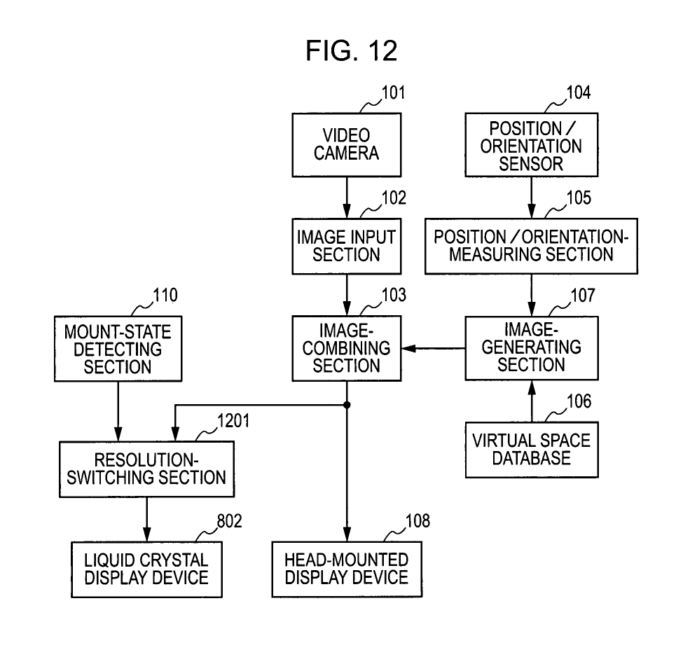

FIG. 12 is a diagram depicting a functional structure of the system according to a fourth embodiment of the present invention. The same components in FIG. 12 as those shown in FIG. 8 are denoted with the same reference numerals, and thus will not be described again here. Referring to FIG. 12, a resolution-switching section 1201 changes the size of the GUI to be displayed on the liquid crystal display device 802 based on a determination result by the mount-state detecting section 110. In addition to the processing carried out by the mount-state detecting section 110 in the first embodiment, the mount-state detecting section 110 also determines whether the observer is looking at the image displayed on the HMD 108, and according to this determination processing result, the resolution-switching section 1201 changes the size of the GUI to be displayed on the liquid crystal display device 802.

The basic structure of the system according to this embodiment is the same as that in the third embodiment.

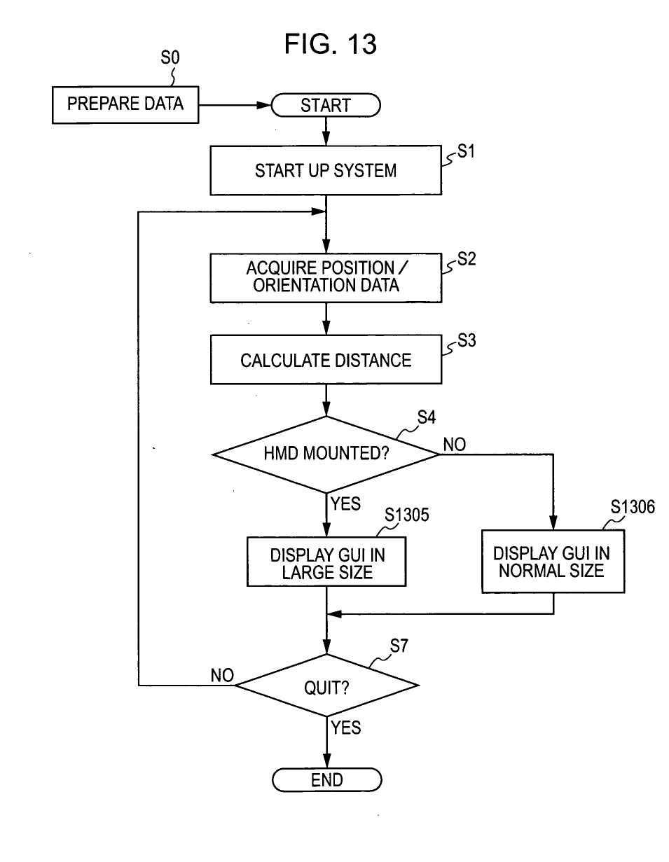

FIG. 13 is a flowchart for the process of changing the size of the GUI displayed on the liquid crystal display device 802 by the computer 1600. Programs and data used by the CPU 1601 to carry out the processing in accordance with the flowchart shown in FIG. 13 are saved in the external storage device 1607. These programs and data are loaded in the RAM 1602 under the control of the CPU 1601, which then uses the loaded programs and data to enable the computer 1600 to carry out the processing to be described later. The processing in accordance with the flowchart shown in FIG. 13 can be called as a subroutine, for example, while this system is presenting the observer with information (the image of the virtual space superimposed upon the image of the real space in this embodiment). For example, the processing in accordance with the flowchart shown in FIG. 13 can be performed at predetermined intervals of time. The same process steps in FIG. 13 as those shown in FIG. 3 are denoted with the same step numbers, and thus will not be described again here.

In step S4, if it is determined that the distance between the initial position pre-registered in the external storage device 1607 in step S0 and the position obtained in step S2 is at least a predetermined distance, the flow is advanced to step S1305. The CPU 1601 increases the size of the GUI to be displayed on the liquid crystal display device 802 and outputs the GUI to the liquid crystal display device 802 (step S1305). On the other hand, if the distance obtained in step S3 is smaller than the predetermined distance, the flow is advanced to step S1306. The CPU 1601 outputs to the liquid crystal display device 802 the GUI to be displayed in normal size (size smaller than the size of the GUI displayed in step S1305) on the liquid crystal display device 802 (step S1306).

As described in the first embodiment, other types of processing are also conceivable to determine whether the observer is looking at the image displayed on the HMD 108. For example, such a determination may be made by detecting a line of sight by the use of the above-described line-of-sight detecting device. In this case, if a line of sight is detected, the size of the GUI displayed on the liquid crystal display device 802 is increased. If no line of sight is detected, the size of the GUI displayed on the liquid crystal display device 802 is set to the normal size.

In addition, such a determination may be made depending on whether the above-described switch provided in the HMD 108 is depressed. In this case, if the switch is depressed, the size of the GUI displayed on the liquid crystal display device 802 is increased. If the switch is not depressed, the size of the GUI displayed on the liquid crystal display device 802 is set to the normal size.

As described above, various types of processing for determining whether or not the observer is looking at the image displayed on the HMD 108 are conceivable.

### Fifth Embodiment

For a system according to this embodiment, various types of commands can be input from the input device, such as the keyboard 1604 and the mouse 1605, only when the observer is looking at the image displayed on the HMD 108. In other words, input of such commands is disabled if the observer is not looking at the image displayed on the HMD 108. This system will be described below.

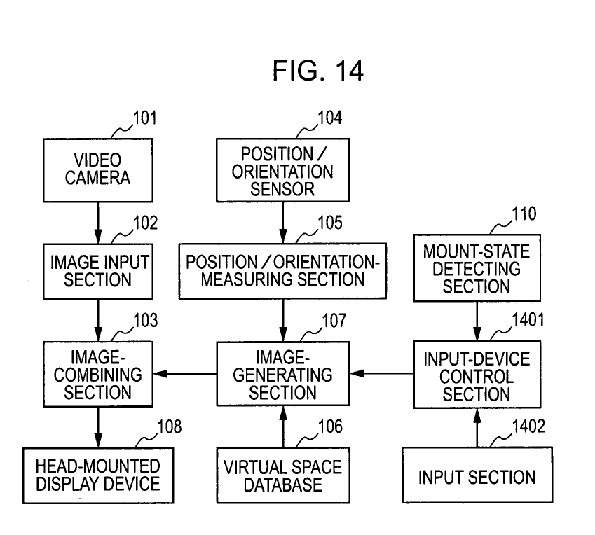

FIG. 14 is a block diagram depicting a functional structure of this embodiment according to the present invention. The same components in FIG. 14 as those shown in FIG. 1 are denoted with the same reference numerals, and thus will not be described again here. An input-device control section 1401 determines whether or not to allow a command input from an input section 1402 according to notification from the mount-state detecting section 110. The input section 1402 corresponds to the input device such as the keyboard 1604 and the mouse 1605.

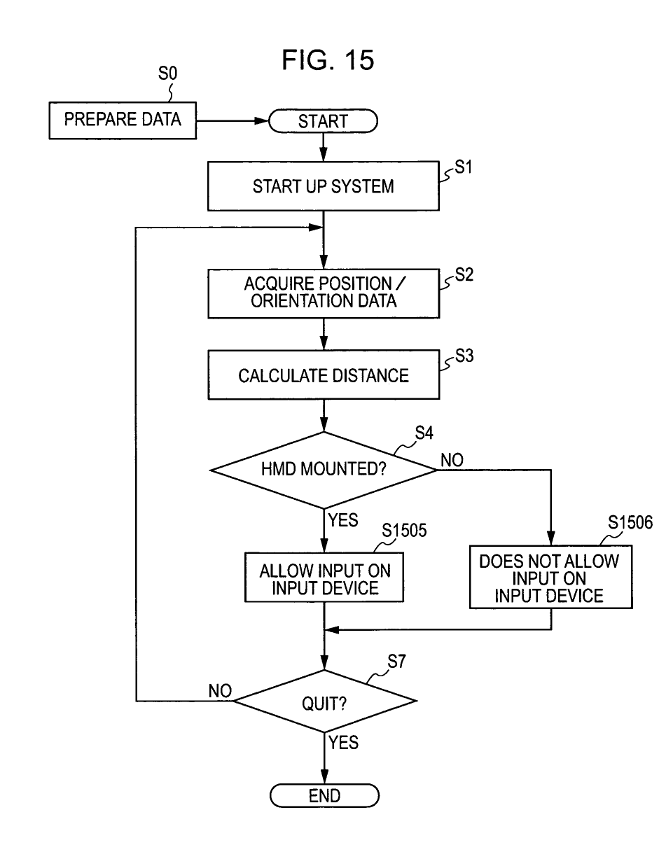

The basic structure of the system according to this embodiment is the same as that in the first embodiment. FIG. 15 is a flowchart for the process of controlling a command input from the input device, such as the keyboard 1604 and the mouse 1605, carried out by the computer 1600. Programs and data used by the CPU 1601 to carry out the processing in accordance with the flowchart shown in FIG. 15 are saved in the external storage device 1607. These programs and data are loaded in the RAM 1602 under the control of the CPU 1601, which then uses the loaded programs and data to enable the computer 1600 to carry out the processing to be described later. The processing in accordance with the flowchart shown in FIG. 15 can be called as a subroutine, for example, while this system is presenting the observer with information (the image of the virtual space superimposed upon the image of the real space in this embodiment). For example, the processing in accordance with the flowchart shown in FIG. 15 can be performed at predetermined intervals of time. The same process steps in FIG. 15 as those shown in FIG. 3 are denoted with the same step numbers, and thus will not be described again here.

In step S4, if it is determined that the distance between the initial position pre-registered in the external storage device 1607 in step S0 and the position obtained in step S2 is at least a predetermined distance, the flow is advanced to step S1505. The CPU 1601 accepts an input command from the input device such as the keyboard 1604 and the mouse 1605 (step S1505).

On the other hand, if the distance obtained in step S3 is smaller than the predetermined distance, the flow is advanced to step S1506. The CPU 1601 does not accept an input command from the input device such as the keyboard 1604 and the mouse 1605 (step S1506).

As described in the first embodiment, other types of processing are also conceivable to determine whether the observer is looking at the image displayed on the HMD 108. For example, such a determination may be made by detecting a line of sight by the use of the above-described line-of-sight detecting device. In this case, if a line of sight is detected, a command input from the input device such as the keyboard 1604 and the mouse 1605 is accepted.

In addition, such a determination may be made depending on whether the above-described switch provided in the HMD 108 is depressed. In this case, if the switch is depressed, a command input from the input device such as the keyboard 1604 and the mouse 1605 is accepted.

As described above, various types of processing for determining whether or not the observer is looking at the image displayed on the HMD 108 are conceivable.

### Sixth Embodiment

In the foregoing embodiments, structures for switching among various ways of providing information (e.g., image and audio) according to whether the observer is looking at the image displayed on the HMD 108 have been discussed. Since the basic processing is the same despite different items of provided information, one or more of the foregoing embodiments can be appropriately combined. Furthermore, information to be provided is not limited to images or audio. Alternatively, other types of information may be provided.

### Seventh Embodiment

In the foregoing embodiments, structures for switching among various ways of providing information (e.g., image and audio) according to whether the observer is looking at the image displayed on the HMD 108 have been discussed. The observer may be verbally prompted to appropriately wear the HMD 108 by determining whether the observer wears the HMD 108 appropriately in the same manner.

### Eighth Embodiment

In the foregoing embodiments, the period of time for which the observer sees the image displayed on the HMD 108 and the period of time for which the observer does not wear the HMD 108 may be measured, so that the observer may be prompted to take off the HMD 108 when the period of time for which the observer wears the HMD 108 reaches a specified time.

For this purpose, a timer for measuring the time elapsed since the power supply is turned ON is provided, so that when the time measured by the timer reaches a predetermined time, a message demanding that the HMD 108 be removed is displayed on the HMD 108.

### Ninth Embodiment

In the foregoing embodiments, structures for switching among various ways of providing information (e.g., image and audio) according to whether the observer is looking at the image displayed on the HMD 108 have been discussed. In this embodiment, information about who is looking at the image on the HMD 108 is provided for control, in addition to information about whether an observer is looking at the image on the HMD 108.

More specifically, appropriately authorized observers only are presented with content by using biological information specific to an individual (e.g., iris of an eye, fingerprint, and blood vessel pattern). In short, information for identifying observers is pre-stored to compare stored information with biological information for control.

### Other Embodiments

The present invention can also be achieved by providing a recording medium (or storage medium) storing software program code for performing the functions of the foregoing embodiments and allowing the CPU or micro-processing unit (MPU) of a camera to read the program code from the recording medium and execute the program. In this case, the program code read from the recording medium achieves the functions of the foregoing embodiments.

As described above, the functions of the foregoing embodiments are achieved with the execution of the program code read by the camera. In addition, the functions of the foregoing embodiments may also be achieved by the operating system (OS) running on the camera that performs all or part of the processing according to the commands of the program code.

Furthermore, the functions of the foregoing embodiments may also be achieved such that the program code read from the recording medium is written to a memory provided in an expansion card disposed in the camera or an expansion unit connected to the camera and then the CPU provided on the expansion card or the expansion unit performs all or part of the processing based on the commands of the program code.

When the present invention is to be applied to the above-described recording medium, program code corresponding to the flowcharts (functional structures) described above is stored in that recording medium.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2004-331104 filed Nov. 15, 2004, which is hereby incorporated by reference herein in its entirety.

What is claimed is:

1. An information processing apparatus comprising:
a determination unit configured to determine a use state of a display device for displaying an image in front of an eye of an observer; and
a control unit configured to control a power supply of the display device based on the use state of the display device determined by the determination unit.

2. The information processing apparatus according to claim 1, further comprising:
a reception unit configured to receive at least one of position information and orientation information about the display device, wherein
the determination unit is configured to determine the use state of the display device based on at least one of the position information and the orientation information received by the reception unit.

3. The information processing apparatus according to claim 2, wherein
the determination unit is configured to determine that the display device is in use if a distance between a position indicated by the position information received by the reception unit and an initial position of the display device is at least a predetermined distance and to determine that the display device is in not in use if the distance between the position indicated by the position information received by the reception unit and the initial position of the display device is smaller than the predetermined distance, and wherein
the control unit is configured to turn the power supply on if the determination unit determines that the display device is in use and to turn the power supply off if the determination unit determines that the display device is not in use.

4. The information processing apparatus according to claim 2, wherein
the determination unit is configured to determine that the display device is in use if the orientation information received by the reception unit indicates a vertically upward direction and to determine that the display device is not in use if the orientation information received by the reception unit does not indicate a vertically upward direction, and wherein
the control unit is configured to turn the power supply on if the determination unit determines that the display device is in use and to turn the power supply off if the determination unit determines that the display device is not in use.

5. The information processing apparatus according to claim 1, further comprising:
a detection unit configured to detect for a line of sight of the observer looking at a display screen of the display device, wherein
the determination unit is configured to determine the use state of the display device based on whether the line of sight of the observer is detected by the detection unit.

6. The information processing apparatus according to claim 5, wherein
the determination unit is configured to determine that the display device is in use if the line of sight of the observer is detected by the detection unit, and to determine that the display device is not in use if no line of sight of the observer is detected by the detection unit, and wherein
the control unit is configured to turns the power supply on if the determination unit determines that the display device is in use and to turn the power supply off if the determination unit determines that the display device is not in use.

7. The information processing apparatus according to claim 6, further comprising:
a supply unit configured to supply the image to a second display device different from the display device, wherein
the control unit is configured to turn the power supply of the second display device on if the control unit turns the power supply of the display device off and to turn the power supply of the second display device off if the control unit turns the power supply of the display device on.

8. The information processing apparatus according to claim 1, further comprising:
an audio input unit configured to input audio indicating a desired command, wherein
the control unit is configured to control a power supply of the audio input unit.

9. The information processing apparatus according to claim 1, further comprising:
a measuring unit configured to measure a usage time of the display device, wherein
the determination unit is configured to determine whether the usage time reaches a predetermined value.

10. The information processing apparatus according to claim 1, further comprising:
a detection unit configured to detect information about the observer, wherein
the determination unit is configured to determine the use state of the display device based on whether the information about the observer detected by the detection unit satisfies a predetermined condition.

11. An information processing apparatus comprising:
a first supply unit configured to supply an image to a first display device for displaying the image in front of an eye of an observer;
a second supply unit configured to supply an image to a second display device for displaying the image in a different format from the format of the first display device;
a reception unit configured to receive at least one of position information and orientation information about the first display device; and
a control unit configured to control a size of the image displayed on the second display device based on at least one of the position information and the orientation information received by the reception unit.

12. The information processing apparatus according to claim 11, further comprising:
a sensor unit configured to sense a line of sight of the observer looking at the first display device; and
a generation unit configured to generate at least one of the position information and the orientation information about the first display device based on the line of sight of the observer sensed by the sensor unit, wherein
the reception unit is configured to receive at least one of the position information and the orientation information generated by the generation unit.

13. The information processing apparatus according to claim 12, further comprising:
an image input unit configured to input an image in a direction of the line of sight of the observer sensed by the sensor unit, wherein
the control unit is configured to increase the size of the image displayed on the second display device if the second display device is included in the image input by the image input unit.

14. An information processing apparatus comprising:
a supply unit configured to supply an image to a display device for displaying the image in front of an eye of an observer;
a detection unit configured to detect information about the observer; and
a restriction unit configured to restrict the image supplied to the display device by the supply unit based on the information detected by the detection unit.

15. The information processing apparatus according to claim 14, wherein the information detected about the observer is at least one of an iris of the observer, a fingerprint of the observer, and a blood vessel pattern of the observer.

16. An information processing method comprising:
a determining step of determining a use state of a display device for displaying an image in front of an eye of an observer; and
a controlling step of controlling a power supply of the display device based on the use state of the display device determined in the determining step.

17. The information processing method according to claim 16, further comprising:
a receiving step of receiving at least one of position information and orientation information about the display device, wherein,
in the determining step, determining the use state of the display device is based on at least one of the position information and the orientation information received in the receiving step.

18. The information processing method according to claim 17, wherein,
in the determining step, it is determined that the display device is in use if a distance between a position indicated by the position information received in the receiving step and an initial position of the display device is at least a predetermined distance and it is determined that the display device is in not in use if the distance between the position indicated by the position information received in the receiving step and the initial position of the display device is smaller than the predetermined distance, and wherein,
in the controlling step, the power supply is turned on if it is determined in the determining step that the display device is in use and the power supply is turned off if it is determined in the determining step that the display device is not in use.

19. The information processing method according to claim 17, wherein,
in the determining step, it is determined that the display device is in use if the orientation information received in the receiving step indicates a vertically upward direction and it is determined that the display device is not in use if the orientation information received in the receiving step does not indicate a vertically upward direction, and wherein,
in the controlling step, the power supply is turned on if it is determined in the determining step that the display device is in use and the power supply is turned off if it is determined in the determining step that the display device is not in use.

20. The information processing method according to claim 16, further comprising:
a detecting step of detecting for a line of sight of the observer looking at a display screen of the display device, wherein,
in the determining step, determining the use state of the display device is based on whether the line of sight is detected in the detecting step.

21. The information processing method according to claim 20, wherein,
in the determining step, it is determined that the display device is in use if the line of sight is detected in the detecting step, and it is determined that the display device is not in use if no line of sight is detected in the detecting step, and wherein,
in the controlling step, the power supply is turned on if it is determined in the determining step that the display device is in use and the power supply is turned off if it is determined in the determining step that the display device is not in use.

22. The information processing method according to claim 21, further comprising:
a supplying step of supplying the image to a second display device different from the display device, wherein,
in the controlling step, the power supply of the second display device is turned on if the power supply of the display device is turned off and the power supply of the second display device is turned off if the power supply of the display device is turned on.

23. The information processing method according to claim 16, further comprising:
an audio input step of inputting audio indicating a desired command by using an audio input unit, wherein,
in the controlling step, a power supply of the audio input unit is controlled.

24. The information processing method according to claim 16, further comprising:
a time usage measuring step of measuring a usage time of the display device, wherein,
in the determining step, determining the use state of the display device is determined based on whether the usage time reaches a predetermined value.

25. The information processing method according to claim 16, further comprising:
a detecting step of detecting information about the observer, wherein,
in the determining step, determining the use state of the display device is determined based on whether the information detected in the detecting step satisfies a predetermined condition.

26. A computer-readable recording medium storing computer-executable instructions for performing an information processing method according to claim 16.

27. An information processing method comprising:
a first supplying step of supplying an image to a first display device for displaying the image in front of an eye of an observer;
a second supplying step of supplying an image to a second display device for displaying the image in a different format from the format of the first display device;
a receiving step of receiving at least one of position information and orientation information about the first display device; and
a controlling step of controlling a size of the image displayed on the second display device based on at least one of the position information and the orientation information received in the receiving step.

28. The information processing method according to claim 27, further comprising:
a sensing step of sensing a line of sight of the observer looking at the first display device; and
a generating step of generating at least one of the position information and the orientation information about the first display device based on the line of sight of the observer sensed in the sensing step, wherein
in the receiving step, at least one of the position information and the orientation information generated in the generating step is received.

29. The information processing method according to claim 28, further comprising:
an inputting step of inputting an image in a direction of the line of sight of the observer, wherein,
in the controlling step, the size of the image displayed on the second display device is increased if the second display device is included in the image input in the inputting step.

30. A computer-readable recording medium storing computer-executable instructions for performing an information processing method according to claim 27.

31. An information processing method comprising:
a supplying step of supplying an image to a display device for displaying the image in front of an eye of an observer;
a detecting step of detecting information about the observer; and
a restricting step of restricting the image supplied to the display device based on the information detected in the detecting step.

32. The information processing method according to claim 31, wherein the information about the observer detected at the detecting step is at least one of an iris of the observer, a fingerprint of the observer, and a blood vessel pattern of the observer.

33. A computer-readable recording medium storing computer-executable instructions for performing an information processing method according to claim 31.
